(19) United States
(12) Patent Application Publication
(10) Pub. No.: US 2025/0284762 A1
(43) Pub. Date: Sep. 11, 2025

(54) METROPOLIS-HASTINGS ADJUSTED CHAOTIC DISCRETE SPACE SAMPLING

(71) Applicant: NTT RESEARCH, INC., Sunnyvale, CA (US)

(72) Inventor: Timothee Guillaume Leleu, Sunnyvale, CA (US)

(73) Assignee: NTT RESEARCH, INC., Sunnyvale, CA (US)

(21) Appl. No.: 19/075,164

(22) Filed: Mar. 10, 2025

Related U.S. Application Data
(60) Provisional application No. 63/563,687, filed on Mar. 11, 2024.

(51) Int. Cl. G06F 17/11

(52) U.S. Cl. CPC G06F 17/11

(57) ABSTRACT

A system may be provided. The system may include one or more processors. The one or more processors may be configured to evolve a dynamic time system mapped to a combination of variables through a deterministic path for a predetermined time period. The one or more processors may further be configured to cause a probabilistic jump of the dynamic time system after the predetermined time period. The one or more processors may also be configured to accept or reject the probabilistic jump based on a Metropolis-Hastings criterion.

### CROSS REFERENCE TO RELATED APPLICATIONS

This application claims priority to U.S. Provisional App. No. 63/563,687 filed Mar. 11, 2024 and entitled “Metropolis-Hastings Adjusted Chaotic Discrete Space Sampling,” which is hereby incorporated by reference in its entirety.

### FIELD

This disclosure relates to physical systems-based computing to solve combinatorial optimization problems.

### BACKGROUND

Classical digital computers consume a lot of energy and time to solve non-deterministic polynomial-time (NP)-hard problems such as combinatorial optimization problems. Special types of physical systems-based computers and devices have been built to overcome these deficiencies of the classical digital computers. A physical system-based computer uses the physical property that the system will ultimately settle at (or converge to) a lowest energy state. Therefore, if a combinatorial optimization problem can be mapped to a physical system, the lowest energy state of the physical system corresponds to the solution (i.e., optimal combination) of the problem. Physical systems-based computers have been found to be efficient (e.g., in terms of energy) for solving the combinatorial optimization problems compared to the classical digital computers.

### SUMMARY

In some embodiments, a system may be provided. The system may include one or more processors. The one or more processors may be configured to evolve a dynamic time system mapped to a combination of variables through a deterministic path for a predetermined time period. The one or more processors may further be configured to cause a probabilistic jump of the dynamic time system after the predetermined time period. The one or more processors may also be configured to accept or reject the probabilistic jump based on a Metropolis-Hastings criterion.

In some embodiments, a method may be provided. The method may include evolving, by one or more processors of a computing system, a dynamic time system mapped to a combination of variables through a deterministic path for a predetermined time period. The method may also include causing, by the one or more processors, a probabilistic jump of the dynamic time system after the predetermined time period. The method may further include accepting or rejecting, by the one or more processors, the probabilistic jump based on a Metropolis-Hastings criterion.

### BRIEF DESCRIPTION OF DRAWINGS

FIG. 1 shows an illustrative computing system, according to example embodiments of this disclosure.

FIG. 2 shows another illustrative computing system, according to example embodiments of this disclosure.

FIG. 3 shows another illustrative computing system, according to example embodiments of this disclosure.

FIG. 4 shows another illustrative computing system, according to example embodiments of this disclosure.

FIG. 5 shows another illustrative computing system, according to example embodiments of this disclosure.

FIG. 6A shows a schematic illustrating a principle of operation of the computing systems of FIGS. 1-5, according to example embodiments of this disclosure.

FIG. 6B shows an example pseudo-code implementing the principle of operation shown in FIG. 6A, according to example embodiments of this disclosure.

FIG. 7 is a flowchart of an example method of calculating an optimal combination, according to example embodiments of this disclosure.

FIG. 8 is a flowchart of an example method of a drug selection, according to example embodiments of this disclosure.

FIG. 9 is a flowchart of an example method of training a machine learning model, according to example embodiments of this disclosure.

The figures are for purposes of illustrating example embodiments, but it is understood that the present disclosure is not limited to the arrangements and instrumentality shown in the drawings. In the figures, identical reference numbers identify at least generally similar elements.

### DESCRIPTION

Embodiments disclosed herein describe significantly improved physical-system based computing devices and methods that are faster and more efficient in performing NP-hard computations such as combinatorial optimization compared conventional physical-system based devices and methods. Additionally, the speed and efficiency gain may not be expense of accuracy. The computing devices and methods may deterministically evolve the state of the computation such that the accuracy is not sacrificed. When it comes to sampling a state, the computing devices and methods may use a probabilistic technique-such as Metropolis-Hastings-such that speed and efficiency is improved.

Particularly, embodiments disclosed herein describe improved computing devices and methods for handling NP hard computations such as determining an optimal combination. An initial combination may include a number of variables (or spins), which may be modeled into a dynamic time system-such as a physical system-which may move toward lower energy states. That is, the dynamic time system may physically move toward lower energy states with concomitant changes to the combination of the number of variables. The combinations of the variables at the lower energy states (or lowest energy states, if feasible) may be the optimal combinations, thereby solving a corresponding combinatorial optimization problem.

In some embodiments, a Markov Chain Monte Carlo method is used to model an evolution of a dynamic time system. To avoid the system being stuck at a local minima, the system is deliberately disturbed using chaotic amplitude control, i.e., some chaos is introduced into the system to increase the likelihood that the system may escape a local minima. Using the Markov Chain Monte Carlo and the chaotic amplitude control, the system may evolve along a deterministic path while being sampled probabilistically. The deterministic evolution retains more information about the system such that higher number of states are maintained thereby increasing the number of state spaces for the probabilistic sampling.

However, the chaotic amplitude control may disturb the detailed balance of the system and the sampling may not be fair. A disturbance in the detailed balance may cause the sampling to be different for different directions. A disturbance in fairness may cause the samples to have a non-uniform distribution. To preserve the detailed balance, samples are selected (i.e., rejected or accepted) based on conditions imposed by Metropolis-Hastings algorithm. The Metropolis-Hastings algorithm may also sample a Boltzmann distribution, thereby providing a fair sampling where all the states may be sampled with equal probabilities. One or more sampled states of the system may provide corresponding optimal combinations of the variables.

Therefore, embodiments disclosed herein may provide a fast and fair sampling in a discrete space even when a dynamical system evolves based on an analog relaxation. The computation may be faster than conventional system because of fast and parallel dynamics that exploit chaotic amplitude control in the analog domain.

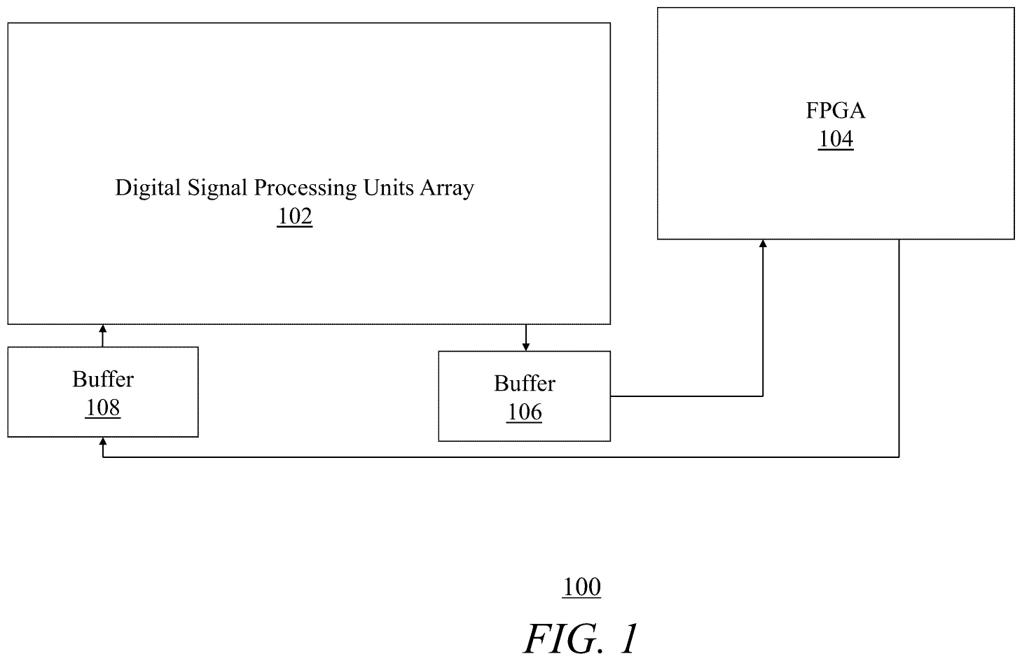

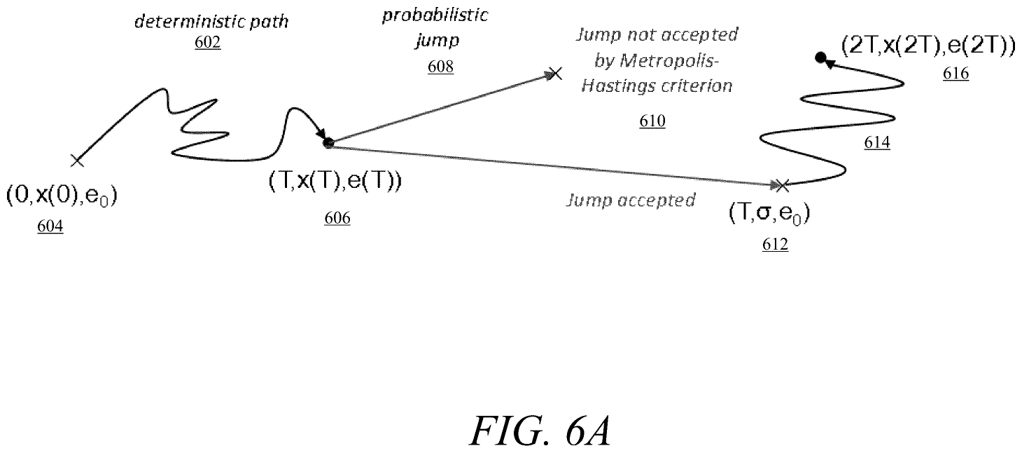

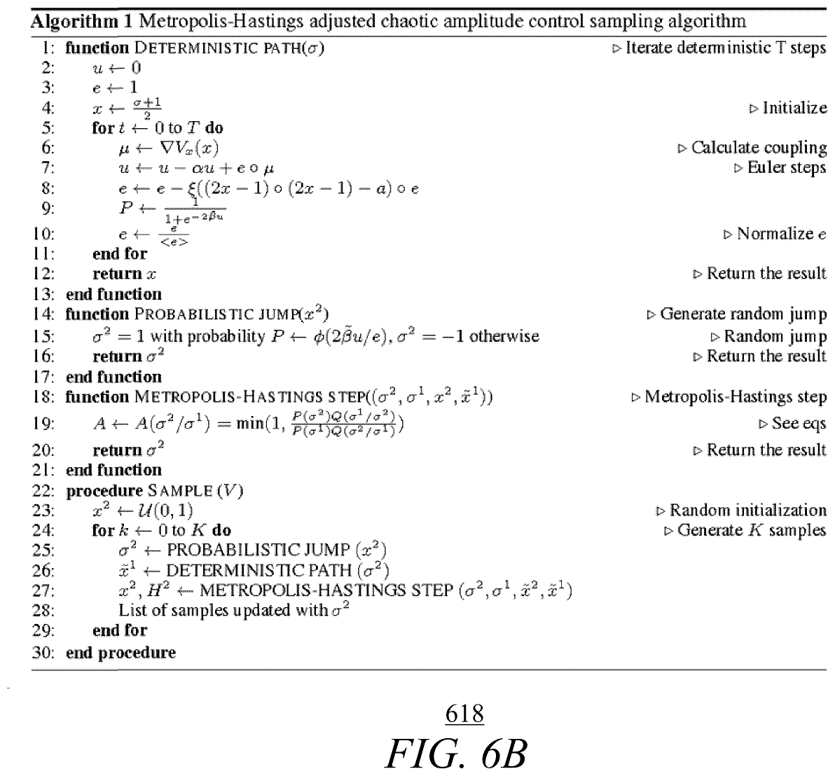

FIG. 1 shows an illustrative computing system 100, according to example embodiments of this disclosure. The computing system 100 may implement both deterministic evolution and the discrete sampling using digital electronics. As shown, a digital signal processing units array 102 may implement the deterministic evolution and the field programmable gate array (FPGA) 104 (collectively referred to as “processors”) may implement the probabilistic sampling. The principle of operation of the deterministic evolution and probabilistic sampling is described in detail with respect to FIGS. 6A-6B below. A buffer 106 may temporarily store data from the digital signal processing units array 102 to the FPGA 104 and a buffer 108 may temporarily store data from the FPGA 104 to the digital signal processing units array 102.

The digital signal processing units array 102 may include any kind of digital signal processing units. Non-limiting examples of digital signal processing units may include graphical processing units (GPUs), FPGAs, central processing units (CPUs). Regardless of the specific types of the digital signal processing units, the digital signal processing units array 102 may perform matrix vector multiplications and non-linear operations on each of the vector x of spins and the auxiliary variables e for a chaotic amplitude control. The matrix vector multiplications and the non-linear operations may generate a new state of the vector x and the auxiliary variables e. In some embodiments, the digital signal processing units array 102 may perform the matrix vector multiplications and non-linear operations with eight bit to sixteen bits floating point precision.

The FPGA 104 may perform probabilistic sampling based on Metropolis-Hastings acceptance criterion. Although the FPGA 104 is used in this embodiment, a CPU may also be used to perform the probabilistic sampling. In some embodiments, the FPGA 104 may not necessarily need a high-bit precision and therefore implement a low bit precision to implement the Metropolis-Hastings acceptance criterion.

The computing system 100 may therefore determine an optimal combination based on individual calculations at the digital signal processing units array 102 and the FPGA 104, and the corresponding results being shared with each other through the buffers 106, 108. That is, the computing system 100 may implement the deterministic evolution and probabilistic sampling for multiple iterations until the optimal combination is reached.

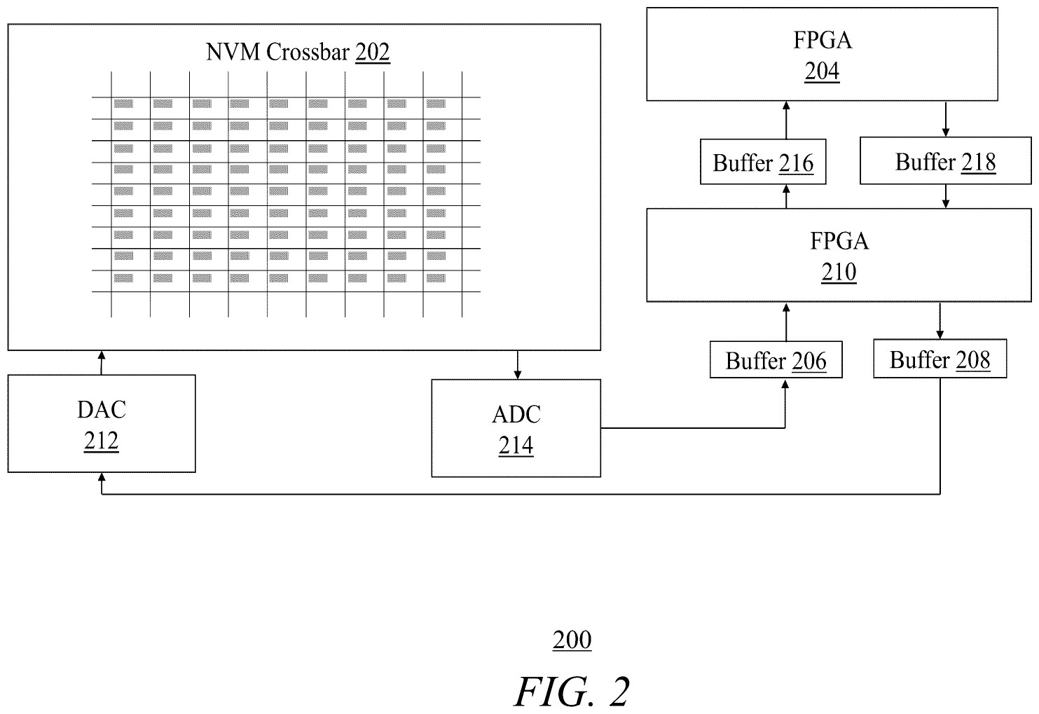

FIG. 2 shows an illustrative computing system 200, according to example embodiments of this disclosure. The computing system 200 may implement a hybrid approach by using both analog electronics and digital electronics. For instance, a non-volatile memory (NVM) crossbar 202 may form an analog electronics portion and the FPGAs 204, 210 and buffers 206, 208, 216, 218 may form a digital electronics portion. An analog to digital converter (ADC) 214 may convert an analog traffic from the analog portion to the digital portion. A digital to analog converter (DAC) 212 may convert a digital traffic from the digital portion to the analog portion.

The NVM crossbar 202 may be formed by any kind of individually addressable memory elements such as memristors. In some embodiments, the NVM crossbar 202 may perform matrix vector multiplications to implement the deterministic evolution. In these embodiments, the NVM crossbar 202 may transmit the results of the matrix vector multiplications to the FPGA 210 through the ADC 214 and the buffer 206 and the FPGA 210 may perform non-linear operations on vector x of spins and the auxiliary variables e. For the non-linear operations, the FPGA 210 in some embodiments may apply an eight to sixteen bits floating point precision.

In some embodiments, the NVM crossbar 202 may perform both the matrix vector multiplication and the non-linear operations on vector x of spins and the auxiliary variables e to implement the deterministic evolution. In these embodiments, the FPGA 210 may not be needed.

Regardless of where the non-linear operations are performed, the FPGA 204 may implement the probabilistic sampling that includes a calculation of a jump and whether the jump should be accepted based on a Metropolis-Hastings acceptance criterion. THE FPGA 204 may implement a low-bit precision (e.g., compared to the FPGA 210) for the probabilistic sampling. The results of the operations by the FPGA 204 may then be fed back to the NVM crossbar 202 through the buffers 218, 208 and DAC 212 for the NVM crossbar to perform a next iteration of the deterministic evolution.

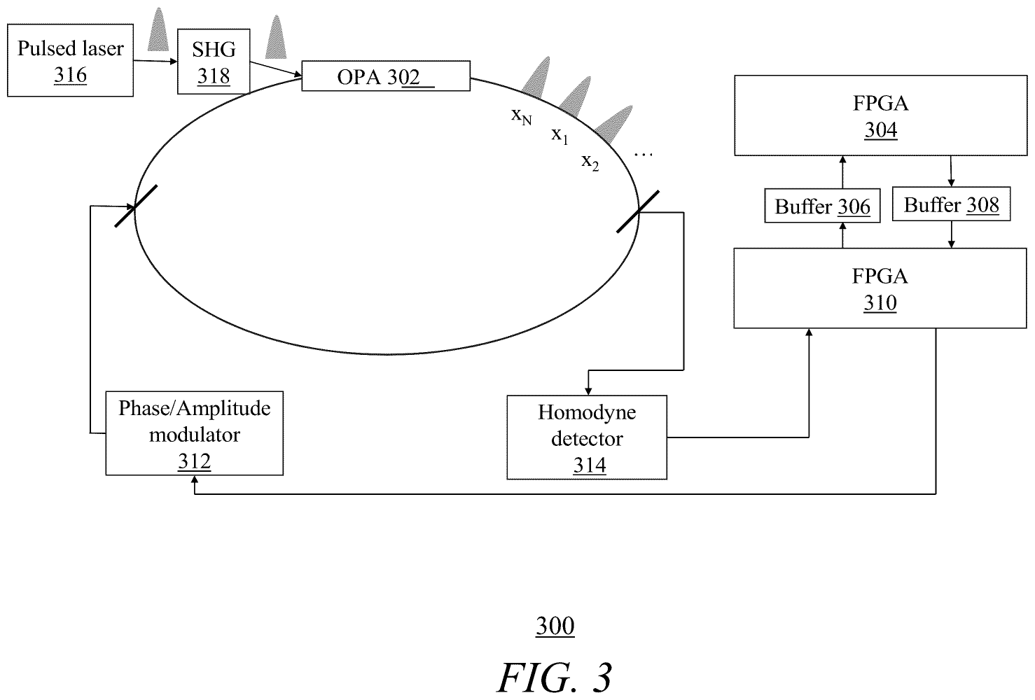

FIG. 3 shows an illustrative computing system 300, according to example embodiments of this disclosure. The computing system 300 may provide an opto-electronic implementation where the matrix vector multiplications are performed optically and the probabilistic samplings are performed electronically (e.g., by using digital electronics).

For the optical portion, the computing system 300 may include an optical parametric amplifier (OPA) 302 that may be used for matrix vector multiplication. In some embodiments, the OPA 302 may be formed using periodically poled lithium niobate. A pulsed laser 316 may input pulses to a second harmonic generator (SHG) 318 that may double the frequency of photons in the pulses, and these pulses may be input into the OPA 302. The pulses resonating within the OPA 302 may form the vector x of spins, which may be used for matrix vector multiplication. The results of the vector matrix multiplication may be captured through a homodyne detector 314.

An FPGA 310 may perform non-linear operations on the vector x of spins and the auxiliary variables e. The calculations from the FPGA 310 may be provided to FPGA 304 through a buffer 306. The FPGA 304 may calculate probabilistic jumps and use Metropolis-Hastings criterion to determine whether to accept the jumps. The results from the FPGA 304 may be provided back to the OPA 302 through the buffer 308 and FPGA 310. A phase/amplitude modulator 312 may apply the results (e.g., an accepted jump) by modulating phase and/or amplitude of the pulses in the OPA 302. The optical matrix vector multiplication, the electronic non-linear operations, and the electronic probabilistic sampling may continue for multiple iterations until an optimal combination is reached.

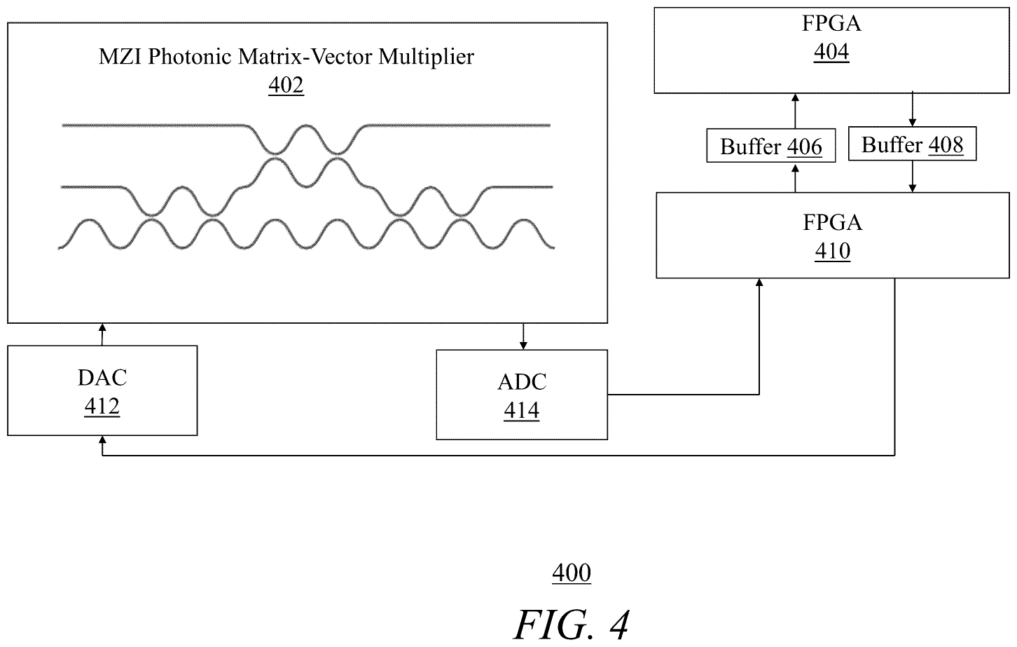

FIG. 4 shows an illustrative computing system 400, according to example embodiments of this disclosure. The computing system 400 may provide an opto-electronic implementation where the matrix vector multiplications may be performed optically and probabilistic samplings may be performed electronically (e.g., in digital electronics domain).

For the optical portion, the computing system 400 may include a Mach-Zehnder Interferometer (MZI) photonic matrix-vector multiplier 402, which may perform the matrix vector multiplication. The results of the matrix vector multiplication may be provided to an FPGA 410 through an ADC 414, where the FPGA may perform non-linear operations on the vector x of spins and auxiliary variables e. The FPGA 410 may provide its result to FPGA 404 through a buffer 406. The FPGA 404 may implement a probabilistic jump and the Metropolis-Hastings criterion to determine whether to accept the jump. The result (e.g., whether or not the jump has been accepted) may be fed back to the MZI photonic matrix-vector multiplier 402 through a buffer 408, FPGA 410, and DAC 412 for a next iteration. The iterations may continue until an optimal combination is reached.

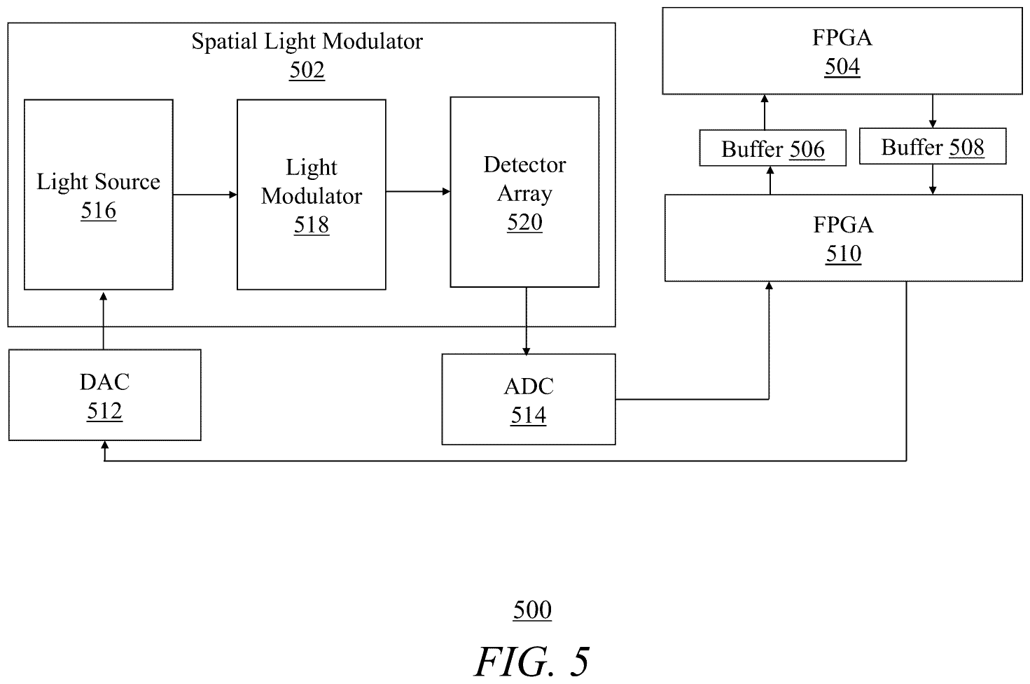

FIG. 5 shows an illustrative computing system 500, according to example embodiments of this disclosure. The computing system 500 may provide an opto-electronic implementation where the matrix vector multiplications are performed optically and probabilistic samplings are performed electronically (e.g., in digital electronics domain).

For the optical portion, the computing system 500 may include a spatial light modulator 502, which may perform the matrix vector multiplication. The multiplication is performed when a light source 516, spatially representing a vector x of spins, is modulated by a light modulator 518, representing a coupling matrix. The result of the modulation, forming the result of the vector matrix multiplication, may be captured by a detector array 520. The result of the matrix vector multiplication may be then converted into digital domain by an ADC 514 and provided to FPGA 510. The FPGA 510 may perform non-linear operations on the vector x and the auxiliary variable e and provide the results to FPGA 504 through a buffer 506. The FPGA 504 may implement a probabilistic jump and the Metropolis-Hastings criterion to determine whether to accept the jump. The result (e.g., whether or not the jump has been accepted) may be fed back to the spatial light modulator 502 through a buffer 508, FPGA 510, and DAC 512 for a next iteration. The iterations may continue until an optimal combination is reached.

FIG. 6A shows a schematic illustrating a principle of operation of the computing systems of FIGS. 1-5, according to example embodiments of this disclosure. The illustrative principle of operation may utilize a hybrid approach where a physical system may be allowed to evolve in a deterministic, analog path but with discrete, digital sampling governed by Metropolis-Hastings algorithm. It should, however, be understood that the principle of operation is provided as an example, and other types of hybrid approaches with analog evolution and discrete sampling governed by other algorithms should be considered within the scope of this disclosure.

As shown, the operation of the computing system may follow a deterministic path 602 from a first state 604 to a second state 606. A sampling at the second state 606 may include determining a probabilistic jump 608 from the second state 606, where the jump may be accepted or not accepted based on Metropolis-Hastings acceptance criterion 610. If the jump is accepted, the computing system may evolve from a jumped state 612 to a third state 616 following another deterministic path 614. Multiple iterative deterministic paths following with probabilistic jumps may be performed until one or more optimal combinations are found.

The operation of the computing system may leverage a continuous time dynamical system with chaotic amplitude control. The continuous time dynamical system with chaotic amplitude control may be generalized as a correspondence between the parameters of the dynamical system and a temperature of a Boltzmann distribution P(σ)∝e^{βV(σ)}, which may characterize disparate states σ of energy V(σ) in thermal equilibrium at the inverse temperature β. This time dynamical system may be used to draw samples from the distribution P(σ) defined on the discrete space x∈{−1, 1}^{N}, where N may the number of variables or spins, whose combination may be optimized.

For the deterministic path 602, the discrete variables σ may be relaxed to an analog space. For such relaxation, a potential (or energy function) V(x) may be defined on a real analog space x ∈ [symbol] ^{N}. The following dynamical system may be used to direct the search to lower energy states corresponding to solutions of the desired combinatorial optimization:

$$\frac{d u}{d t} = - α u - e ∘ {∇}_{x} V$$

where u may be state of the system, ∘ may denote a Hadamard product, ∇ₓ may be a gradient of V with respect to a vector x, α may be a positive parameter (in some embodiments set to 0.5), and e may be a vector of positive auxiliary variables introducing chaotic amplitude control. The vector x may be set as follows to represent N spins:

$${x}_{i} = ϕ ( \tilde{β} {u}_{i} ) , {∀}_{i} ∈ \{ 1 , … , N \}$$

where \tilde{β} may be the effective inverse temperature of Boltzmann distribution, and where

$$ϕ ( x ) = \frac{2}{1 + {e}^{- x}} - 1$$

may be sigmoid function normalized to the domain x∈]−1, 1 [.

The auxiliary variables et may undergo chaotic amplitude control dynamics over time to rectify amplitude heterogeneity or to stabilize flipping rate of spins. The dynamic changes to the vector e may be defined as follows:

$$\frac{d e}{d t} = - ξ ( x ∘ x - a ) ∘ e$$

where α may be a target amplitude term and ξ may be a speed of error correction term.

The sampling, however, may be discretized—and the above equation for dynamic changes to the state u and the auxiliary variables vector e may have to be accordingly discretized. A Euler approximation may be used to convert the equations to:

$$u ( u + 1 ) = u - α u ( t ) - e {∇}_{x} V x ( t ) ,$$

$$e ( t + 1 ) = e ( t ) - ζ ( x ( t ) ∘ x ( t ) - a ) ∘ e ( t ) )$$

Using such discretization, the deterministic path 602 may show an evolution of vector x from time (t)=0 at the first state 604 to t=T at the second state 606. That is, in between the first state 604 and the second state 606, the above discretized equations may be iterated for T time steps.

Subsequent to the iteration for T time steps along the deterministic path 602 from the first state 604 to the second state 606, a discrete state σ∈{−1, 1}^{N} may be sampled as the probabilistic jump 608. The sampling may be as follows:

$$P ( {σ}_{i} = 1 ) = \frac{{x}_{i} + 1}{2} ,$$

$${σ}_{i} = - 1 otherwise .$$

All the N spins may be updated synchronously and independently. While the deterministic path 602 over T time steps may include local updates to state u, the probabilistic jump 608 to generate σ by sampling may cause the system to discontinuously jump to remote states. Furthermore, if ξ=0, eᵢ(0)=0, α=1, T=1 and if one spin i is updated at a time, the above dynamics may revert to the equation of a Boltzmann machine.

However, with the introduction of chaotic amplitude control with ξ≠0, the detailed balance is broken. The generated Markov Chain may also deviate from Boltzmann distribution and fair sampling may therefore be disturbed. To maintain the detailed balance and to have a Monte Carlo Markov Chain converging to a Boltzmann distribution, the Metropolis-Hastings acceptance criterion 610 may be used on discrete state samples σ (KT), where k may belong to {1, 2, . . . , K}.

The Metropolis-Hastings acceptance criterion 610 of a new configuration σ², when a current state σ¹ is given may be as follows:

$$A ( {σ}^{2} / {σ}^{1} ) = min ( 1 , \frac{P ( {σ}^{2} ) Q ( {σ}^{1} / {σ}^{2} )}{P ( {σ}^{1} ) Q ( {σ}^{2} / {σ}^{1} )} )$$

where Q(σ²/σ¹) may represent a probability of transitioning from σ¹ to σ². The Monte Carlo steps for the hybrid formulation therefore structured as:
(1) Deterministic dynamics along the deterministic path 602 using the discretized equations for u and e for T steps starting from the initial (first) state 604 where u(kT)=\vec{0}, e(kT)=\vec{0}, and x(kT)=σ¹(kT).
(2) A probabilistic sample σ² generated at the probabilistic jump 608 with probability

$${P}^{2} = \frac{{x}^{2} + 1}{2}$$

with x²=x(kT).

x(kT) may rely on σ¹ because x(kT) may be generated along the deterministic path 602 that may commence from σ¹. Because of the synchronous updating of all spins, the following expression for Q(σ²/σ¹) may be generated as follows:

$$log Q ( {σ}^{2} / {σ}^{1} ) = {\sum }_{i = 1}^{N} \frac{1 + {σ}_{i}^{2}}{2} log ( {P}^{2} ) + \frac{1 - {σ}_{i}^{2}}{2} log ( 1 - {P}^{2} )$$

To calculate a transition probability in the reverse Monte Carlo step from σ² to σ¹, the deterministic dynamics of (1) may have to applied from σ¹ to obtain a candidate end point \tilde{x}¹ from which a probability of generating a random sample σ¹ with probability

$${\tilde{P}}^{1} = \frac{{\tilde{x}}^{1} + 1}{2}$$

may be calculated. The Metropolis-Hastings acceptance criterion A can be rewritten as follows:

$$log A ( {σ}^{2} / {σ}^{1} ) = min ( 1 , β ( V ( {σ}^{1} ) - V ( {σ}^{2} ) - {\sum }_{i = 1}^{N} [ \frac{1 + {σ}_{i}^{2}}{2} log ( {P}_{i}^{2} ) + \frac{1 - {σ}_{i}^{2}}{2} log ( 1 - {P}_{i}^{2} ) ] + {\sum }_{i = 1}^{N} [ \frac{1 + {σ}_{i}^{2}}{2} log ( {\tilde{P}}_{i}^{1} ) + \frac{1 - {σ}_{i}^{2}}{2} log ( 1 - {\tilde{P}}_{i}^{1} ) ] )$$

The above acceptance criterion may be computed efficiently because it involves logarithms of terms already computed within the deterministic equations. As shown, the discrete step σ² may be accepted with probability A(σ²/σ¹). The Markov Chain using the Metropolis-Hastings step may achieve detailed balance condition and may converge to the target Boltzmann distribution

$$P ( x ) = {e}^{- β V ( x )} .$$

FIG. 6B shows an example pseudo-code 618 implementing the principle of operation shown in FIG. 6A, according to example embodiments of this disclosure.

An example test of Markov Chain constructed using the above principle of operation may be performed by sampling a Boltzmann distribution of an Ising Hamiltonian

$$V ( σ ) = - {\sum }_{ij} {w}_{ij} {σ}_{i} {o}_{j}$$

of a Wishard planted instance of size N=18 spins at an inverse temperature β. The Wishard planted instances may allow for a generation of random instances of tunable complexity and known ground-state. The Boltzmann distribution is determined and distance between the Boltzmann distribution and the sampled distribution is estimated through simulation. An optimal effective inverse temperature \tilde{β}* may be determined as a linear function of the inverse temperature β of the Boltzmann distribution.

Using the principles of operations above, embodiments disclosed herein allow for sampling at different temperatures, thereby increasing the likelihood of converging on an optimal solution of the combinatorial optimization problem.

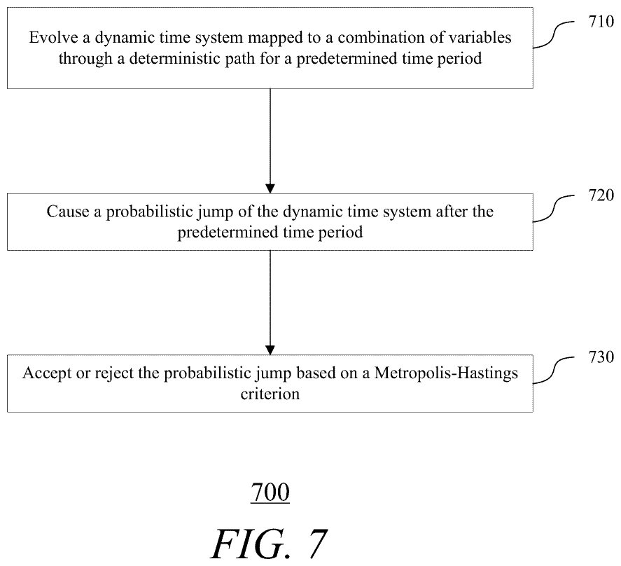

FIG. 7 is a flowchart of an example method 700 of calculating an optimal combination, according to example embodiments of this disclosure. The method 700 may be implemented by any of the computing systems 100, 200, 300, 400, 500.

The method may begin at step 710, where a computing system may evolve a dynamic time system mapped to a combination of variables through a deterministic path for a predetermined time period. The deterministic path may be an analog relaxation portion that may preserve different states of the dynamic time system, where the states may be lost if only a discrete sampling was employed.

At step 720, the computing system may cause a probabilistic jump of the dynamic time system after the predetermined time period. The computing system may further sample a state of the dynamic time system at the probabilistic jump.

At step 730, the computing system may accept or reject the probabilistic jump based on a Metropolis-Hastings criterion. Using the Metropolis-Hastings criterion may preserve the detailed balance of the samples, e.g., of having jumps of equal probabilities regardless of the direction.

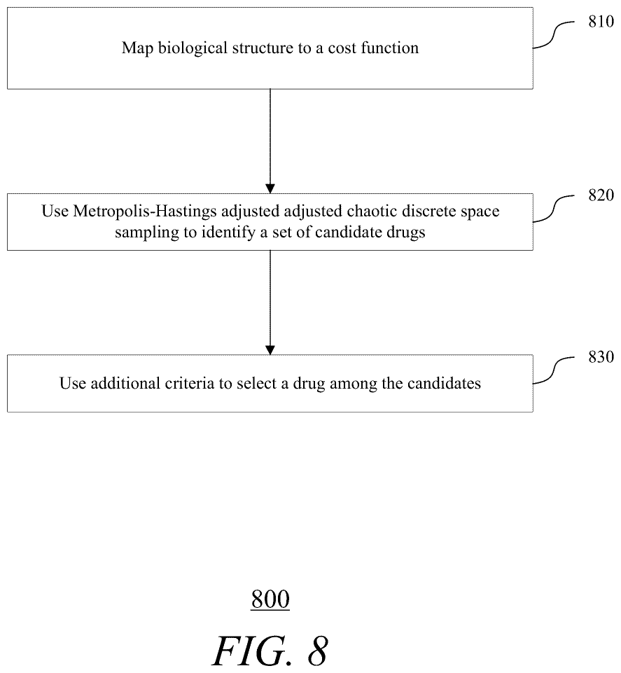

FIG. 8 is a flowchart of an example method 800 of a drug selection, according to example embodiments of this disclosure. The method may be performed by any of computing systems 100, 200, 300, 400, 500.

The method 800 may begin at step 810, where a computing system may map a biological structure to a cost function. The biological structure may form a target for a drug. The biological structure may include, for example, a protein, a genome, etc. In some embodiments, the cost function may be an Ising Hamiltonian, as understood in the art.

At step 820, the computing system may use Metropolis-Hastings adjusted chaotic discrete sampling, as described throughout this disclosure, to identify a set of candidate drugs. The candidate drugs may include an optimal combinations of drug forming compounds, where the optimal combinations may be associated with minimum points of the cost function.

At step 830, additional criteria may be used to select a drug among the candidates. For example, there may be new practical constraints not included in the initial modeling, and these constraints may force some optimal combinations to be rejected. Additionally, experimental testing may call for rejecting other optimal combinations. After the rejections, a drug (or multiple drugs) with an optimal combination may be selected for further research and/or patient use.

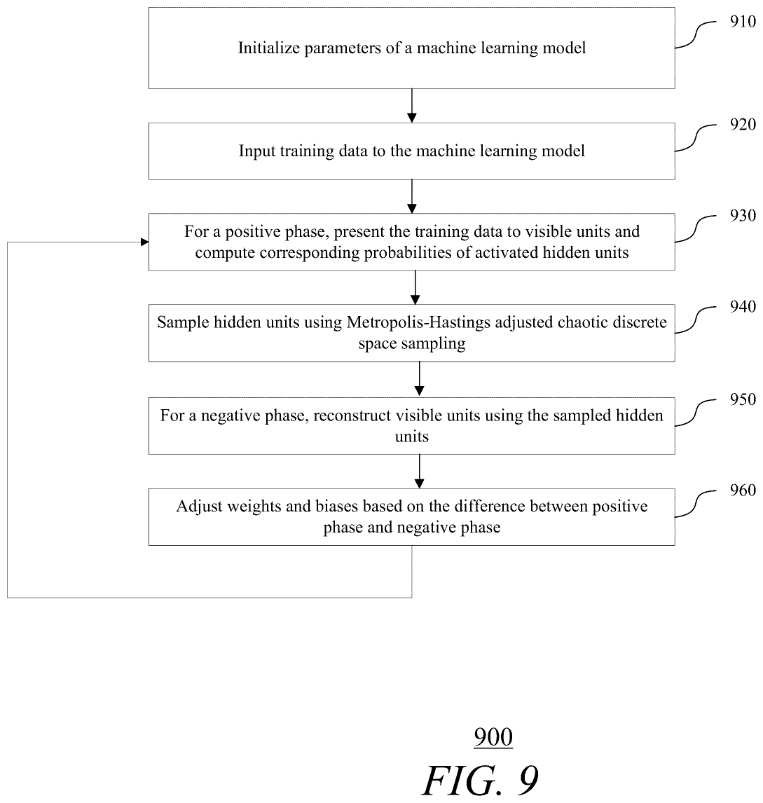

FIG. 9 is a flowchart of an example method 900 of training a machine learning model, according to example embodiments of this disclosure. The method may be performed by any of computing systems 100, 200, 300, 400, 500. In some embodiments, the machine learning model may be a Boltzmann machine.

At step 910, a computing system may initialize parameters of the machine learning model. The initialized parameters may include, for example, weights and biases. In some embodiments, the computing system may randomly initialize the parameters.

At step 920, the computing system may input training data to the machine learning model. For a Boltzmann machine, the training may unsupervised and therefore the training data may be unlabeled. The training data may include any kind of data including but not limited to, images, text, etc.

At step 930, the computing system may perform a positive phase of training. The positive phase of training may include presenting the training data to visible units (e.g., visible units of a Boltzmann machine) and computing corresponding probabilities of activated hidden units (e.g., hidden units of the Boltzmann machine). The positive phase of training therefore may include propagation of information from visible units to hidden units.

At step 940, the computing system may sample hidden units, regardless of whether they were activated at step 930 using Metropolis-Hastings adjusted chaotic discrete sampling, described throughout this disclosure.

At step 950, the computing system may perform a negative phase of the training. The negative phase may include reconstructing visible units using sampled hidden units. The negative phase may therefore include propagation of information from the hidden units to the visible units.

At step 960, the computing system may adjust weights and biases based on the differences between the positive phase and the negative phase. In some embodiments, the differences may include difference between (1) outer products of probabilities and activated hidden units during the positive phase, and (2) outer products of probabilities and sampled hidden units during the negative phase. The computing system may perform multiple iterations of steps 930-960 until a desired difference is reached.

The methods described throughout this disclosure are just example methods and should not be considered limiting. That is, methods with additional, alternative, or fewer number of steps should also be considered within the scope of this disclosure.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A computing system comprising:
one or more processors configured to:
evolve a dynamic time system mapped to a combination of variables through a deterministic path for a predetermined time period;
cause a probabilistic jump of the dynamic time system after the predetermined time period; and
accept or reject the probabilistic jump based on a Metropolis-Hastings criterion.

2. The computing system of claim 1, the one or more processors comprising one or more of an optical processor, an analog processor, or a digital processor.

3. The computing system of claim 1, the one or more processors comprising a first digital processor and a second digital processor, the first digital processor having a higher bit precision than the second digital processor, the first digital processor being configured to evolve the dynamic time system, and the second digital processor configured to cause the probabilistic jump and to accept or reject the probabilistic jump.

4. The computing system of claim 1, the one or more processors comprising an analog processor and a digital processor, the analog processor configured to evolve the dynamic time system, and the digital processor configured to cause the probabilistic jump and to accept or reject the probabilistic jump.

5. The computing system of claim 1, the one or more processors configured to discretely sample a state of the dynamic time system at the probabilistic jump.

6. The computing system of claim 1, the one or more processors configured to discretely sample a state of the dynamic time system at an inverse temperature at the probabilistic jump.

7. The computing system of claim 1, the one or more processors configured to determine an optimal combination of the variables after iterating the dynamic time system through multiple deterministic paths and multiple probabilistic jumps.

8. The computing system of claim 7, the one or more processors configured to discretely sample corresponding states of the dynamic time system at the multiple probabilistic jumps, the sampled corresponding states being in a Boltzmann distribution.

9. The computing system of claim 1, the one or more processors configured to accept or reject the probabilistic jump based on the Metropolis-Hastings criterion to preserve a detailed balance of the dynamic time system.

10. The computing system of claim 1, the one or more processors configured to insert chaotic amplitude control to the dynamic time system during the evolution of the dynamic time system through the deterministic path.

11. A method comprising:
evolving, by one or more processors of a computing system, a dynamic time system mapped to a combination of variables through a deterministic path for a predetermined time period;
causing, by the one or more processors, a probabilistic jump of the dynamic time system after the predetermined time period; and
accepting or rejecting, by the one or more processors, the probabilistic jump based on a Metropolis-Hastings criterion.

12. The method of claim 11, the one or more processors comprising at least of an optical processor, an analog processor, or a digital processor.

13. The method of claim 11, the one or more processors comprising a first digital processor and a second digital processor, the first digital processor having a higher bit precision than the second digital processor, the method further comprising:
evolving, by the first digital processor, the dynamic time system mapped to the combination of variables through the deterministic path for the predetermined time period;
causing, by the second digital processor, the probabilistic jump of the dynamic time system after the predetermined time period; and
accepting or rejecting, by the second digital processor, the probabilistic jump based on the Metropolis-Hastings criterion.

14. The method of claim 11, the one or more processors comprising an analog processor and a digital processor, the method further comprising:
evolving, by the analog processor, the dynamic time system mapped to the combination of variables through the deterministic path for the predetermined time period;
causing, by the digital processor, the probabilistic jump of the dynamic time system after the predetermined time period; and
accepting or rejecting, by the digital processor, the probabilistic jump based on the Metropolis-Hastings criterion.

15. The method of claim 11, further comprising:
discretely sampling, by the one or more processors, a state of the dynamic time system at the probabilistic jump.

16. The method of claim 11, further comprising:
discretely sampling, by the one or more processors, a state of the dynamic time system at an inverse temperature at the probabilistic jump.

17. The method of claim 11, further comprising:
determining, by the one or more processors, an optimal combination of the variables after iterating the dynamic time system through multiple deterministic paths and multiple probabilistic jumps.

18. The method of claim 17, further comprising:
discretely sampling, by the one or more processors, corresponding states of the dynamic time system at the multiple probabilistic jumps, the sampled corresponding states being in a Boltzmann distribution.

19. The method of claim 11, further comprising:
accepting or rejecting, by the one or more processors, the probabilistic jump based on the Metropolis-Hastings criterion to preserve a detailed balance of the dynamic time system.

20. The method of claim 11, further comprising:
inserting, by the one or more processors, chaotic amplitude control to the dynamic time system during the evolution of the dynamic time system through the deterministic path.
